(19) United States
(12) Patent Application Publication
(10) Pub. No.: US 2015/0293973 A1
(43) Pub. Date: Oct. 15, 2015

(54) MANAGING ELECTRONIC RECORDS

(71) Applicant: Bank of America Corporation, Charlotte, NC (US)

(72) Inventors: James A. Blanchard, III, Midland, NC (US); Heather J. Hagan, Charlotte, NC (US); Julie A. Knutson, Charlotte, NC (US)

(73) Assignee: Bank of America Corporation, Charlotte, NC (US)

(21) Appl. No.: 14/253,623

(22) Filed: Apr. 15, 2014

(51) Int. Cl. G06F 17/30

(52) U.S. Cl. CPC G06F 17/30507; G06F 17/30864; G06F 17/30091; G06F 2201/80

(57) ABSTRACT

A system for managing electronic records comprises one or more memories comprising one or more databases, the databases configured to store a plurality of electronic records; one or more user interfaces configured to receive electronic records and criteria to associate the electronic records to one or more enterprise functions, technology platforms, and enterprise rules, and receive a query for one or more of the one or more electronic records, enterprise functions, technology platforms, and enterprise rules; and one or more processors configured to associate, according to the received criteria, the one or more electronic records with the one or more enterprise functions, technology platforms, and enterprise rules, and determine one or more electronic records, enterprise functions, technology platforms, and enterprise rules responsive to the received query.

### TECHNICAL FIELD

This invention relates generally to electronic records and more particularly to managing electronic records in one or more databases.

### BACKGROUND OF THE INVENTION

Enterprises often perform various functions to provide products and services to customers. Many enterprise functions, such as sales, are applicable to a number of different products and services and to a number of enterprise employees. Enterprises often maintain large numbers of electronic records that are applicable enterprise functions, technology platforms, and/or rules governing enterprise functions and/or technology platforms. However, due to the number of electronic records, it is difficult to identify electronic records that are applicable to particular enterprise functions. The difficulty of identifying applicable electronic records is exacerbated when enterprise employees are grouped into discrete subdivisions that may have little interaction, but that may perform similar or identical enterprise functions. An enterprise employee seeking to perform an enterprise function may not be aware that another enterprise employee has generated electronic records applicable to the enterprise function, and may have no way of finding the applicable electronic record. Accordingly, enterprise employees often generate duplicative and/or redundant electronic records instead of using existing electronic records. Duplicative and/or redundant electronic records waste both human and electronic resources (e.g., memory, bandwidth, processing resources, etc.) Additionally, duplicative and/or redundant electronic records may be inconsistent with existing electronic records, may not comply with applicable rules, and may use different, and potentially less suitable, technology platforms.

### SUMMARY OF THE INVENTION

According to embodiments of the present disclosure, disadvantages and problems associated with managing electronic records may be reduced or eliminated.

In certain embodiments, a system for managing electronic records comprises one or more memories comprising one or more databases, at least one of the one or more databases configured to store a plurality of electronic records; one or more user interfaces communicatively coupled to at least one of the one or more memories, the one or more interfaces configured to receive one or more electronic records and criteria to associate the one or more electronic records to one or more enterprise functions, technology platforms, and enterprise rules, and receive a query for one or more of the one or more electronic records, enterprise functions, technology platforms, and enterprise rules; and one or more processors communicatively coupled to at least one of the one or more memories, the one or more processors configured to associate, according to the received criteria, the one or more electronic records with the one or more enterprise functions, technology platforms, and enterprise rules, and determine one or more electronic records, enterprise functions, technology platforms, and enterprise rules responsive to the received query.

Certain embodiments of the present disclosure may provide one or more technical advantages having specific technical effects. For example, in an embodiment, an electronic record management system is operable to identify electronic records applicable to an enterprise function, thereby conserving the computational resources, bandwidth, and memory consumed by generating and maintaining duplicative electronic records

In another embodiment, an electronic record management system is operable to identify technology platforms applicable to an electronic record, thereby conserving the computational resources, bandwidth, and memory consumed by obtaining and maintaining duplicative technology platforms.

In yet another embodiment, an electronic record management system is operable to identify rules associated with electronic records, enterprise functions, and/or technology platforms, thereby reducing the computational resources, bandwidth, and memory consumed by identifying and correcting improper use of electronic records, enterprise functions, and/or technology platforms.

Other technical advantages of the present disclosure will be readily apparent to one skilled in the art from the following figures, descriptions, and claims. Moreover, while specific advantages have been enumerated above, various embodiments may include all, some, or none of the enumerated advantages.

### BRIEF DESCRIPTION OF THE DRAWINGS

To provide a more complete understanding of the present invention and the features and advantages thereof, reference is made to the following description taken in conjunction with the accompanying drawings, in which:

FIG. 1 illustrates a block diagram of an example embodiment of a system for managing electronic records;

FIGS. 2A and 2B illustrate block diagrams of example embodiments of an electronic record taxonomy that may be implemented by the system; and

FIG. 3 illustrates a flow chart of an example embodiment of a method for managing electronic records.

### DETAILED DESCRIPTION OF THE DRAWINGS

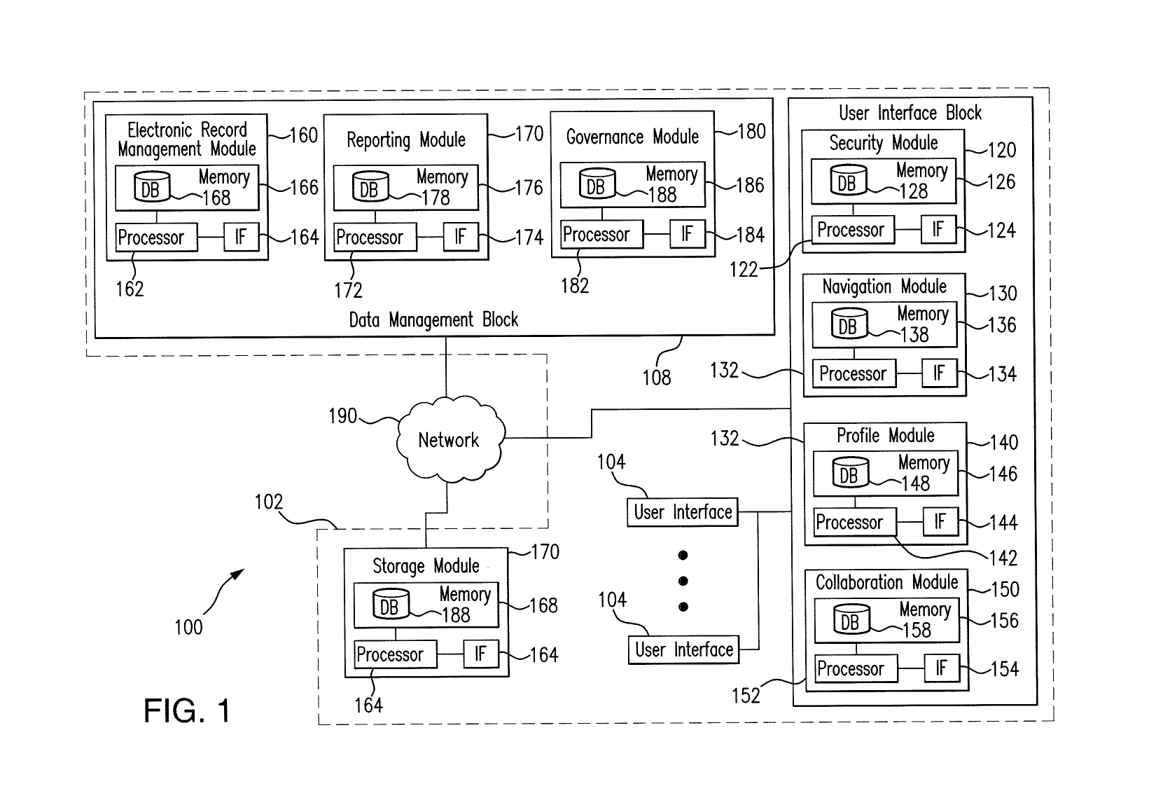

Embodiments of the present disclosure and its advantages are best understood by referring to FIGS. 1 through 3 of the drawings, like numerals being used for like and corresponding parts of the various drawings.

Enterprises perform various enterprise functions in the course of business (e.g., sales, marketing, customer service, research and development, etc.). An enterprise may have technology platforms associated with enterprise functions. For example, an enterprise function may sell products and/or services and the enterprise may maintain various technology platforms associated with sales (e.g., customer relationship management platforms, e-mail marketing platforms, customer intake platforms, sales management platforms, inventory management platforms, etc.). Additionally, an enterprise may have rules associated with an enterprise function and/or technology platform. For example, an enterprise function may be subject to enterprise rules (e.g., product qualifications, pricing restrictions, minimum order sizes, etc.), legal rules (e.g., product disclosure regulations, customer qualification regulations, etc.), and technology platform rules (e.g., data formatting, technology constraints, technology platform user privileges, etc.).

Often, enterprises maintain large volumes of electronic records associated with one or more of enterprise functions, technology platforms, and/or enterprise rules. Electronic records represent electronic data and may be documents, presentations, analysis, metadata, contacts, historical data, or any other type of electronic data. Due in part to the volume and diversity of electronic records maintained by enterprises, it is often difficult or impossible to locate electronic records related to particular enterprise functions, technology platforms, and/or enterprise rules. For example, an enterprise employee tasked with developing a sales strategy for a new product may be unaware of, and/or unable to locate, electronic records associated with applicable enterprise sales functions, enterprise sales rules, and/or sales technology platforms.

In certain embodiments, a system for managing electronic records associates electronic records with one or more of enterprise functions, enterprise rules, and technology platforms. Electronic records may be arranged in a taxonomy that is organized by enterprise functions and identifies enterprise rules, technology platforms, and/or electronic records associated with enterprise functions. In certain embodiments, a user interface block allows system users to submit electronic records, associate electronic records with enterprise functions, enterprise rules, technology platforms, and/or other electronic records, search enterprise records (e.g., by enterprise function), and collaborate with other users to interact with electronic records (e.g., providing reviews, editing, providing associations with enterprise functions, enterprise rules, technology platforms, and/or electronic records, etc.). The system for managing electronic records may include a data management block operable to index electronic records (e.g., according to an enterprise function taxonomy), enforce electronic record governance rules (e.g., formatting rules, metadata rules, retention rules, etc.), generate reports and/or other analytics associated with enterprise functions, enterprise rules, technology platforms, and/or electronic records, and associates electronic records and enterprise functions, enterprise rules, technology platforms, and/or electronic records (e.g., based on pre-determined and/or user submitted criteria). In particular embodiments, a system for managing electronic records includes a storage module comprising one or more databases operable to store a plurality of electronic records.

FIG. 1 illustrates a block diagram of an example embodiment of a system 100 for managing electronic records. In the illustrated embodiment, system 100 includes, enterprise 102, user interfaces 104, user interface block 106, data management block 108, storage module 110, and network 190. User interface block 106 may include security module 120, navigation module 130, profile module 140, and collaboration module 150. Data management block 108 may include electronic record management module 160, reporting module 170, and governance module 180.

Enterprise 102 represents an entity that maintains and/or operates user interfaces 104, user interface block 106, data management block 108, storage module 110, security module 120, navigation module 130, profile module 140, collaboration module 150, electronic record management module 160, reporting module 170, and governance module 180. Enterprise 102 may be any suitable type of business entity. In certain embodiments, enterprise 102 has different business units or subdivisions that handle different business activities. Different subdivisions of enterprise 102 may maintain and/or operate one or more of user interfaces 104, user interface block 106, data management block 108, storage module 110, security module 120, navigation module 130, profile module 140, collaboration module 150, electronic record management module 160, reporting module 170, and/or governance module 180. In particular embodiments, enterprises 102 may include organizations such as commercial banks, savings and loan associations, credit unions, Internet banks, mutual fund companies, brokerage firms, credit card companies, or other provider of electronic transaction services.

User interfaces 104 represent user access points to system 100. User interfaces 104 may be hardware and/or software, web portals, or any other suitable interface to system 100. In certain embodiments, user interfaces require user authentication credentials in order to access system 100. User interface block 106 represents a set of modules operable to facilitate user interaction with system 100. In the illustrated embodiment, user interface block 106 includes security module 120, navigation module 130, profile module 140, and collaboration module 150. Data management block 108 represents a set of modules operable to control electronic records within system 100. In the illustrated embodiment, data management block 108 includes electronic record management module 160, reporting module 170, and governance module 180.

Storage module 170 represents a component of system 100 operable to store electronic records for system 100. Electronic records represent electronic data, such as documents, database elements, metadata, data structure, or any other type of electronic data. Electronic records may be in any suitable format, for example, Microsoft Office formats (e.g., Word, Excel, PowerPoint, Access, Outlook, Visio, etc.), custom formats, proprietary formats, or any other electronic data format. In certain embodiments storage module 170 includes a plurality of databases, each database acting as a repository for particular categories of electronic records. Electronic record categories may include enterprise function models and/or maps, enterprise rules (e.g., business rules, legal rules, technology platform rules, and/or any other suitable rules), technology platform architectural designs, technology platform applications, technology platform services, electronic record inputs and/or outputs, or any other suitable category of electronic record. In certain embodiments, storage module 170 includes processor 172, interface 174, memory 176, and database 178.

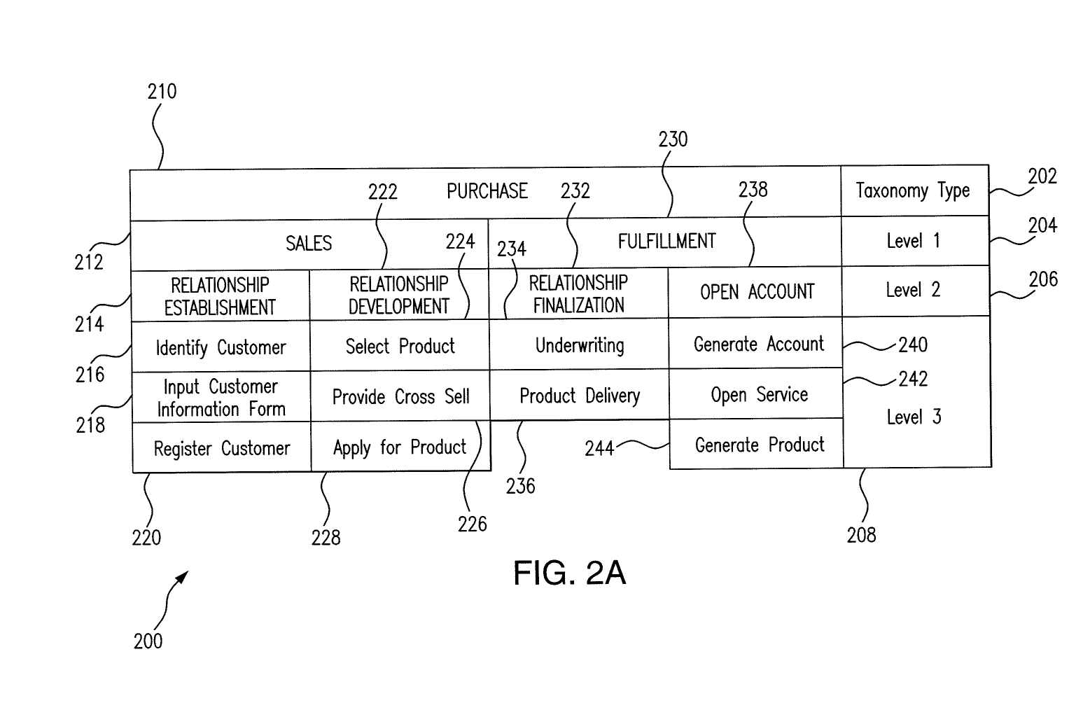

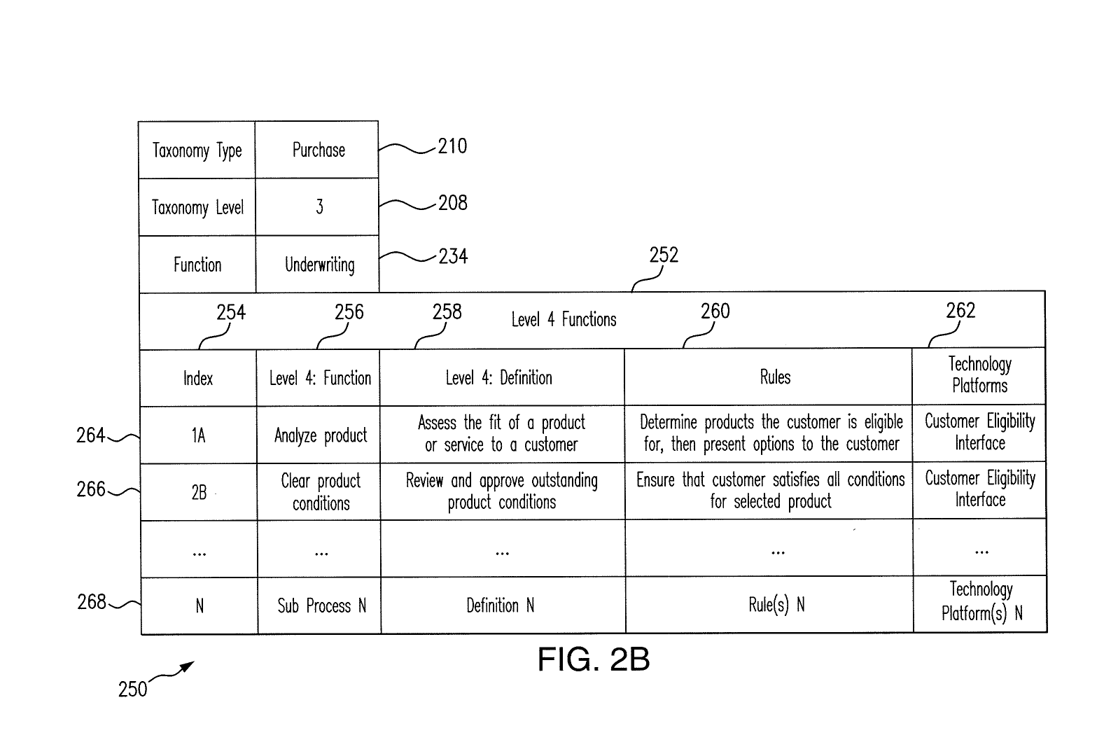

Enterprise functions represent functions performed within enterprise 102 that have defined rules governing the performance of the function. For example, enterprise functions may include sales, marketing, customer service, research and development, product/service fulfillment, regulatory compliance, or any other suitable function. In certain embodiments, enterprise functions are arranged into a taxonomy that organizes electronic records by enterprise function. FIGS. 2A and 2B, described in detail below, illustrate a portion of an example taxonomy of example enterprise functions. Technology platforms represent enterprise technological resources associated with particular enterprise functions. Technology platforms may include hardware systems, software systems, applications, service modules, communication protocols, or any other suitable enterprise technology resource. Enterprise rules represent rules applicable to particular enterprise functions and/or technology platforms. Enterprise rules may include rules promulgated by enterprise 102 (e.g., business rules), legal rules (e.g., laws, regulations, codes, etc.), and technology platform rules (e.g., data formats, technology requirements, communication protocols, etc.)

Security module 120 represents a component of system 100 operable to support security restrictions of system 100. In an embodiment, security module 120 authenticates users attempting to access system 100 through user interface 104, for example, by comparing user authentication credentials to a database of authorized user credentials. Security module 120 may allow users submitting authorized authentication credentials to access system 100 and prevent users submitting unauthorized or invalid user authentication credentials. In certain embodiments, authorized users have a corresponding user profile for system 100. Security module 120 may restrict the system privileges of user profiles based on the access privileges associated with the corresponding user credentials. For example, if particular user credentials are not authorized to edit documents, then security module 120 may disable edit functions on the user profile corresponding to the user credentials. In an embodiment, security module 120 is operable to identify and react to malicious attempts to access system 100 and/or attempts to introduce malicious files to system 100. Security module 120 may be operable to identify attacks on system 100, for example, distributed denial of service, phishing, spoofing, Trojan files, spyware, or any other communication intended to gain unauthorized access to system 100. In certain embodiments, security module 120 includes processor 122, interface 124, memory 126, and database 128.

Navigation module 130 represents a component of system 100 operable to support user navigation and/or interaction with system 100. In certain embodiments, navigation module 130 is operable to support searching, filtering, and/or browsing of electronic records on system 100. Navigation module 130 may be operable to support users submitting electronic records to system 100, updating electronic records on system 100, and/or associating electronic records on system 100 with enterprise functions, enterprise rules, technology platforms, and/or other electronic records. In certain embodiments, navigation module 130 is operable to support users submitting criteria to system 100 for associating electronic records with enterprise functions, enterprise rules, technology platforms, and/or other electronic records. Electronic records may be associated with enterprise functions, enterprise rules, technology platforms, and/or other electronic records according to one or more of creation date, author, keywords, metadata, file type, or any other suitable characteristic of an electronic record. In certain embodiments, navigation module 130 includes processor 132, interface 134, memory 136, and database 138.

Profile module 140 represents a component of system 100 operable to control the functionality of user profiles and/or user interfaces 104. In certain embodiments, profile module 140 is operable to receive user interface 104 preferences (e.g., personalization of user interface 104 options) and apply those preferences to a corresponding user profile. For example, profile module 140 may allow a user to automatically receive particular notifications, particular content, to change and/or manipulate the display of user interfaces 104, or any other suitable functionality related to the display and/or content of user interfaces 104 and/or the user profile. Notifications represent messages communicated to a user profile in response to predefined criteria. For example, a user may want a notification if edits are made to particular documents, new documents are associated with particular enterprise functions, enterprise rules, and/or technology platforms, or any other suitable criteria. In certain embodiments, profile module 140 includes processor 142, interface 144, memory 146, and database 148.

Collaboration module 150 represents a component of system 100 operable to support a plurality of users (e.g., user profiles) interacting with electronic records. In certain embodiments, collaboration module 150 supports multiple users generating electronic records, editing electronic records, rating electronic records, reviewing electronic records, associating electronic records with enterprise functions, enterprise rules, technology platforms, search optimization, metatagging, and/or electronic records. In certain embodiments, collaboration module 150 includes processor 152, interface 154, memory 156, and database 158.

Electronic record management module 160 represents a component of system 100 operable to support access and manipulation of electronic records on system 100. In certain embodiments, electronic record management module 160 is operable to index electronic records. Electronic record management module 160 may be operable to index electronic records according to particular criteria and may be operable to index electronic records in accordance with a predefined taxonomy. FIGS. 2A and 2B, described in detail below, illustrate a portion of an example taxonomy of example enterprise functions. In an embodiment, electronic records are indexed according to enterprise function and grouped with associated enterprise rules and/or technology platforms. Accordingly, a user may identify a particular enterprise function and quickly identify related electronic records, technology platforms, enterprise rules, and related enterprise functions. In particular embodiments, electronic records are indexed according to user submitted criteria. Electronic record management module 160 may control access and manipulation of electronic records on system 100. For example, particular electronic records may be restricted and such that only particular user profiles are allowed to manipulate (e.g., edit) the electronic record. In certain embodiments, the relationships between electronic records and enterprise functions, enterprise rules, technology platforms, and/or electronic records are restricted such that only particular user profiles are allowed to create or edit the relationships. In certain embodiments, electronic record management module 160 includes processor 162, interface 164, memory 166, and database 168.

Reporting module 170 represents a component of system 100 operable to generate reports relating to electronic records on system 100. In certain embodiments, reporting module 170 is operable to generate notification messages, electronic record catalogs, analytics, and/or other suitable content based on electronic records on system 100. Reporting module 170 may be operable to generate content (e.g., reports, analysis, notifications, or other content) based on criteria, for example, received from user interfaces 104. In an embodiment, reporting module 170 is operable to generate a catalog of electronic records on system 100. Reporting module 170 may be operable to generate an index of electronic records on system 100. In particular embodiments, reporting module 170 organizes reports and/or indexes of electronic records in the form of a taxonomy organized according to enterprise function. FIGS. 2A and 2B, described in detail below, illustrate a portion of an example taxonomy of example enterprise functions. In certain embodiments, reporting module 170 includes processor 172, interface 174, memory 176, and database 178.

Governance module 180 represents a component of system 100 operable to enforce enterprise rules governing system 100. Governance module 180 may be operable to require electronic records on system 100 conform to predetermined rules governing system 100, for example, regarding the format of electronic records on system 100, protocols for editing, adding, deleting, associating, or otherwise manipulating electronic records, hardware and/or software requirements, bandwidth requirements, data standards and/or guidelines, or any other suitable type of data governance. In certain embodiments, governance module 180 includes processor 182, interface 184, memory 186, and database 188.

Network 190 represents any suitable network operable to facilitate communication between components of system 100, such as enterprise 102, user interfaces 104, user interface block 106, data management block 108, storage module 110, security module 120, navigation module 130, profile module 140, collaboration module 150, electronic record management module 160, reporting module 170, and governance module 180. Network 190 may include any interconnecting system capable of transmitting audio, video, electrical signals, optical signals, data, messages, or any combination of the preceding. Network 190 may include all or a portion of a public switched telephone network (PSTN), a public or private data network, a local area network (LAN), a metropolitan area network (MAN), a wide area network (WAN), a local, regional, or global communication or computer network, such as the Internet, a wireline or wireless network, an enterprise intranet, or any other suitable communication link, including combinations thereof, operable to facilitate communication between the components of system 100.

A module (e.g., modules 110, 120, 130, 140, 150, 160, 170, and 180) may execute any suitable operating system, such as IBM's zSeries/Operating System (z/OS), MS-DOS, PC-DOS, MAC-OS, WINDOWS, a .NET environment, UNIX, OpenVMS, Android, iOS, Windows Phone, Blackberry BBX, Blackberry 10, Firefox OS, Symbian, Tizen, Ubuntu OS, or any other appropriate operating system, including future operating systems. The functions of a module may be performed by any suitable combination of one or more servers or other components at one or more locations. In embodiments where modules represent a server, the server may be a private server, and the server may be a virtual or physical server. Additionally, a module may include any suitable component that functions as a server.

Components of system 100, such as user interfaces 104, user interface block 106, data management block 108, storage module 110, security module 120, navigation module 130, profile module 140, collaboration module 150, electronic record management module 160, reporting module 170, and governance module 180, may include one or more processors. A processor represents any computing device, such as processors 112, 122, 132, 142, 152, 162, 172, and 182, configured to control the operation of one or more components of system 100. A processor may comprise one or more processors and may be a programmable logic device, a microcontroller, a microprocessor, any suitable processing device, or any suitable combination of the preceding. A processor includes any hardware, including software running on the hardware, that operates to control and process information received by a component of system 100. In certain embodiments, a processor communicatively couples to other components of system 100, such as a module (e.g., modules 110, 120, 130, 140, 150, 160, 170, and 180), an interface (e.g., interfaces 114, 124, 134, 144, 154, 164, 174, and 184), a memory (e.g., memories 116, 126, 136, 146, 156, 166, 176, and 186), a database (e.g., databases 118, 128, 138, 148, 158, 168, 178, and 188), or any other suitable component.

An interface represents any device, such as interfaces 114, 124, 134, 144, 154, 164, 174, and 184, operable to receive input, send output, process the input or output, or perform other suitable operations for a component of system 100. An interface includes any port or connection, real or virtual, including any suitable hardware or software, including protocol conversion and data processing capabilities, to communicate through network 190. In certain embodiments, an interface includes a user interface (e.g., physical input, graphical user interface, touchscreen, buttons, switches, transducer, or any other suitable method to receive input from a user).

A memory represents any device, such as memories 116, 126, 136, 146, 156, 166, 176, and 186, operable to store, either permanently or temporarily, data, operational software, or other information for a processor. Memory includes any one or a combination of volatile or non-volatile local or remote devices suitable for storing information. For example, a memory may include random access memory (RAM), read only memory (ROM), magnetic storage devices, optical storage devices, semiconductor storage devices, or any other suitable information storage device or a combination of these devices. A memory may include any suitable information for use in the operation of component of system 100. A memory may further include some or all of one or more databases (e.g., databases 118, 128, 138, 148, 158, 168, 178, and 188). Databases, such as databases 118, 128, 138, 148, 158, 168, 178, and 188, may be include subdivisions also referred to as databases. For example, database 118 of storage module 110 may include a plurality of databases for different types of electronic records (e.g., enterprise function models and/or maps, enterprise rules, technical platform architectures, data inputs/outputs, etc.).

Logic may perform the operation of any component of system 100, for example, logic executes instructions to generate output from input. Logic may include hardware, software, or other logic. Logic may be encoded in one or more non-transitory, tangible media, such as a computer-readable medium or any other suitable tangible medium, and may perform operations when executed by a computer or processor. Certain logic, such as a processor, may manage the operation of a component.

In an embodiment of operation, user interfaces 104 provide access platforms for users to access system 100. Users may submit user authentication credentials from user interfaces 104 and security module 120 may authenticate the user authentication credentials to determine whether the user is authorized to access system 100. If security module 120 determines that the user authentication credentials are valid, the user is able to access system 100 through user interface 104.

In an embodiment, navigation module 130 supports user interaction with system 100. For example, navigation module 130 may allow a user to browse, search, and filter electronic records and to submit, update, retrieve, edit, and otherwise manipulate electronic records on system 100. In particular embodiments, a user may not be authorized to perform certain functions on system 100, such as editing or deleting particular electronic records. Accordingly, security module 120 may restrict particular functions of navigation module 130 with respect to particular electronic records for a particular user. In an embodiment, electronic records submitted to system 100 are analyzed by security module 120 to ensure that electronic records are not malicious (e.g., viruses, spyware, etc.). Storage module 110 may store electronic records submitted to system 100.

Profile module 140 may support user customization of user interface 104. In certain embodiments, profile module 140 enables users to customize one or more of the display of user interface 104, notifications sent to the user (e.g., through a user profile on system 100), content sent to the user, or any other suitable feature of interface 104 and/or content available through interface 104. Collaboration module 150 may support a plurality of users interacting with electronic records (e.g., generating, editing, indexing, associating, reviewing, rating, commenting, or otherwise interacting with electronic records). In certain embodiments, storage module 110 stores content generated relating to electronic records, for example, reviews, associations, indexes, ratings, comments, or any other suitable content.

In certain embodiments, electronic record management module 160 associates electronic records with one or more of enterprise functions, enterprise rules, technology platforms, and electronic records. Electronic record management module 160 may associate electronic records according to criteria. For example, electronic record management module 160 may receive association criteria and may apply the criteria to electronic records to generate associations. In an embodiment, electronic records submitted to system 100 are submitted with corresponding association criteria (e.g., identifying an associated enterprise function, enterprise rule, technology platform, or electronic record associated with the submitted electronic record). Electronic record management module 160 may be operable to generate an index of electronic records on system 100. In an embodiment, electronic records are indexed according to enterprise function and grouped with associated enterprise rules and/or technology platforms.

Reporting module 170 may be operable to generate notification messages, electronic record catalogs, analytics, and/or other suitable content based on electronic records on system 100. In certain embodiments, reporting module 170 is operable to generate content (e.g., reports, analysis, notifications, or other content) based on criteria, for example, received from user interfaces 104. In an embodiment, reporting module 170 is operable to generate a catalog of electronic records on system 100.

Governance module 180 may be operable to require electronic records on system 100 to conform to predetermined rules governing system 100, for example, regarding the format of electronic records on system 100, protocols for editing, adding, deleting, associating, or otherwise manipulating electronic records, hardware and/or software requirements, bandwidth requirements, or any other suitable type of data governance. Governance module 180 may prevent an electronic record from being submitted to system 100 until the electronic record complies with the applicable rules governing system 100.

Modifications, additions, or omissions may be made to system 100. System 100 may include more, fewer, or other components. Any suitable component of system 100 may include a processor, interface, logic, memory, or other suitable element.

FIGS. 2A and 2B illustrate block diagrams of example embodiments of an electronic record taxonomy that may be implemented by system 100. In certain embodiments, electronic records on system 100 are organized (e.g., by electronic record management module 160) into a taxonomy where electronic records are grouped according to enterprise function. FIG. 2A illustrates a block diagram 200 of a portion of an example electronic record taxonomy that may be implemented by system 100. Diagram 200 includes taxonomy type 202, taxonomy level 1 204, taxonomy level 2 206, and taxonomy level 3 208. Taxonomy type 202 represents the identification of a particular portion of a taxonomy. In the illustrated embodiment, taxonomy type 202 includes purchase block 210. Purchase block 210 may represent the enterprise function of selling products and/or services and fulfilling orders for products and/or services. In the illustrated embodiment, purchase block 210 is subdivided into a number of other enterprise functions, each function corresponding to a particular level of the taxonomy. Purchase block 210 may include level 1 204 enterprise functions represented by sales block 212 and fulfillment block 230.

Sales block 212 includes level 2 206 enterprise functions represented by relationship establishment block 214 and relationship development block 222. In the illustrated embodiment, relationship establishment block 214 includes level 3 208 enterprise functions represented by identify customer block 216, input customer information form block 218, and register customer block 218. Relationship development block 222 may include level 3 208 enterprise functions represented by select product block 224, provide cross sell block 226, and apply for product block 228. Fulfillment block 230 may include includes level 2 206 enterprise functions represented by relationship finalization block 232 and open account block 238. In the illustrated embodiment, relationship finalization block 232 includes level 3 208 enterprise functions represented by underwriting block 234 and product delivery block 236. Open account block 238 may include level 3 208 enterprise functions represented by generate account block 240, open service block 242, and generate product block 244.

In certain embodiments, user interfaces 104 are operable to display electronic records organized by enterprise function as in the taxonomy illustrated in FIG. 2A. Users may be able to interact with the taxonomy through user interfaces 104 to identify electronic records related to particular enterprise functions. For example, an enterprise employee tasked with generating the purchase framework for a new product and/or service may access system 100 and identify purchase block 210 (e.g., through searching, filtering, browsing, or otherwise navigating system 100). Once purchase block 210 is identified, a user can easily identify related enterprise functions (e.g., blocks 212-244) associated with purchase block 210. In certain embodiments, the taxonomy is interactive and a user may select a particular block to obtain additional information about the enterprise function represented by the block. For example, a user may select underwriting block 234 to access information illustrated by FIG. 2B.

FIG. 2B illustrates a block diagram 250 of an example electronic record taxonomy that may be implemented by system 100. In the illustrated embodiment, diagram 250 represents an example taxonomy of underwriting block 234. Diagram 250 may identify the portions of the larger taxonomy displayed, for example, purchase block 210, taxonomy level 3 208, and underwriting block 234, to maintain continuity for a user between taxonomy levels. In an embodiment, diagram 250 includes a table of level 4 252 functions of level 3 208 underwriting block 234. The table may include index column 254, level 4 function column 256, level 4 definition column 258, rules column 262, and technology platforms column 262.

In certain embodiments, index column 254 includes an index identifier for a particular enterprise function described by level 4 function column 256. The index identifier may be used by system 100 in organizing enterprise functions into a taxonomy, to identify particular enterprise functions, or for any other suitable purpose. In an embodiment, level 4 function column 256 includes a description of an enterprise function within the scope of selected underwriting block 234. Level 4 definition column 258 represents a predetermined definition of the corresponding level 4 function described in column 256. The definition may provide a description of how to perform the corresponding level 4 function. Rules column 260 represents an identification of enterprise rules corresponding to the level 4 function identified in column 256. In certain embodiments, rules column 260 includes enterprise rules associated with one or more technology platforms associated with the level 4 function identified in column 256. Technology platforms column 262 represents technology platforms associated with the level 4 function identified in column 256. Technology platforms may include hardware systems, software systems, applications, service modules, communication protocols, or any other suitable enterprise technology resource.

Diagram 250 includes rows 264, 266, and 268. In the illustrated embodiment, the index column 254 of row 264 includes index identifier 1A, the level 4 function column 256 includes the enterprise function “analyze product,” the level 4 definition column 258 includes the definition of “assess the fit of a product or service to a customer,” the rules column 260 includes the enterprise rule “determine products the customer is eligible for, then present options to the customer,” and the technology platforms column 262 includes “customer eligibility interface.” Accordingly, row 264 illustrates that a level 4 function (e.g., sub-function) of the level 3 208 enterprise function underwriting 234 is to “analyze product” which has a definition meaning to “assess the fit of a product or service to a customer,” that an enterprise rule associated with “analyze product” is to “determine products the customer is eligible for, then present those options to the customer” and that a technology platform associated with this functionality is the “customer eligibility interface.”

In the illustrated embodiment, the index column 254 of row 266 includes index identifier 2B, the level 4 function column 256 includes the enterprise function “clear product conditions,” the level 4 definition column 258 includes the definition of “review and approve outstanding product conditions,” the rules column 260 includes the enterprise rule “ensure that customer satisfies all conditions for selected product,” and the technology platforms column 262 includes “customer eligibility interface.” Accordingly, row 266 illustrates that a level 4 function (e.g., sub-function) of the level 3 208 enterprise function underwriting 234 is to “clear product conditions,” which has a definition meaning to “review and approve outstanding product conditions,” that an enterprise rule associated with “clear product conditions” is to “ensure that customer satisfies all conditions for selected product,” and that a technology platform associated with this functionality is the “customer eligibility interface.” Row 268 includes “N” values for all columns, indicating that diagram 250 can include any number of rows and column values.

Modifications, additions, or omissions may be made to diagrams 200 and/or diagram 250. Diagrams 200 and/or 250 may include more, fewer, or other components. For example, diagrams 200 and 250 may include more, fewer, or other taxonomy types 202, levels, level 1 blocks 204, level 2 blocks 206, level 3 blocks 208, level 4 blocks 256, index blocks 254, definition blocks 258, rules blocks 260, technology platform blocks 262, or any other suitable organization of enterprise functions. In certain embodiments, rules column 260 and/or technology platforms column 262 may include large amounts of data not suited to a column, and may represent different tables associated with corresponding level 4 functions 256.

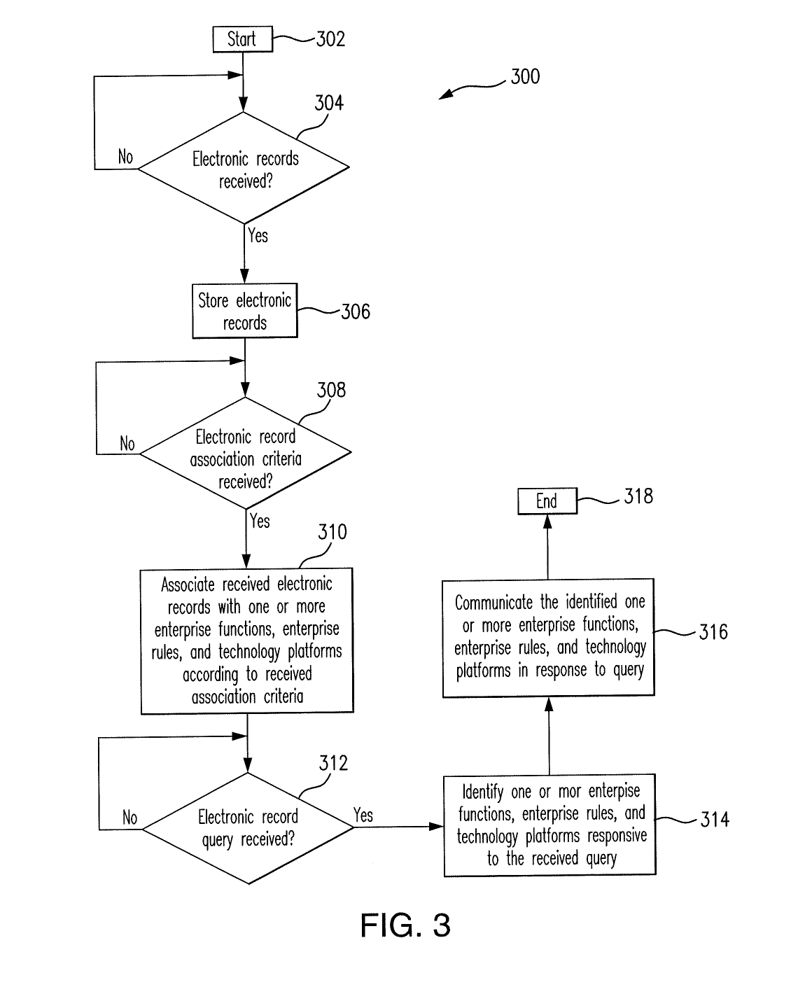

FIG. 3 illustrates a flow chart of an example embodiment of a method 300 for managing electronic records. Method 300 beings at step 302. At step 304, it is determined whether electronic records have been received (e.g., from user interfaces 104). If electronic records have not been received, the method returns to step 304. If electronic records have been received, the method continues to step 306. At step 306, the received electronic records are stored (e.g., in storage module 170). At step 308, it is determined whether association criteria for the received electronic records has been received (e.g., from user interfaces 104). If association criteria has not been received, the method returns to step 308. If association criteria has been received, the method continues to step 310. At step 310, electronic records are associated with one or more enterprise functions, enterprise rules, and technology platforms according to the received association criteria. At step 312, it is determined whether a query relating to an electronic record has been received (e.g., from user interfaces 104). If a query has not been received the method returns to step 312. If a query has been received, the method continues to step 314. At step 314, one or more enterprise functions, enterprise rules, and technology platforms responsive to the received query are identified. At step 316, the identified one or more enterprise functions, enterprise rules, and technology platforms are communicated in response to the query (e.g., to user interfaces 104). At step 318, the method ends.

Modifications, additions, or omissions may be made to method 300. The method may include more, fewer, or other steps. Additionally, steps may be performed in any suitable order, in parallel, and/or sequentially. Any suitable component of may perform one or more steps of method 300.

Certain embodiments of the present disclosure may provide one or more technical advantages having specific technical effects. For example, in an embodiment, an electronic record management system is operable to identify electronic records applicable to an enterprise function, thereby conserving the computational resources, bandwidth, and memory consumed by generating and maintaining duplicative electronic records

In another embodiment, an electronic record management system is operable to identify technology platforms applicable to an electronic record, thereby conserving the computational resources, bandwidth, and memory consumed by obtaining and maintaining duplicative technology platforms.

In yet another embodiment, an electronic record management system is operable to identify rules associated with electronic records, enterprise functions, and/or technology platforms, thereby reducing the computational resources, bandwidth, and memory consumed by identifying and correcting improper use of electronic records, enterprise functions, and/or technology platforms.

Other technical advantages of the present disclosure will be readily apparent to one skilled in the art from the following figures, descriptions, and claims. Moreover, while specific advantages have been enumerated above, various embodiments may include all, some, or none of the enumerated advantages.

Although the present disclosure has been described with several embodiments, diverse changes, substitutions, variations, alterations, and modifications may be suggested to one skilled in the art, and it is intended that the disclosure encompass all such changes, substitutions, variations, alterations, and modifications as fall within the spirit and scope of the appended claims.

What is claimed is:

1. A system for managing electronic records, comprising:
one or more memories comprising one or more databases, at least one of the one or more databases configured to store a plurality of electronic records;
one or more user interfaces communicatively coupled to at least one of the one or more memories, the one or more interfaces configured to:
receive user authentication credentials for a user profile authorized to access the one or more memories, the user profile having defined system privileges associated with one or more of accessing, editing, and associating electronic records in the one or more databases;
receive user interface preferences associated with the user profile, the user interface preferences operable to control one or more of:
provisioning of information associated with the electronic records to the user profile; and
provisioning of notifications related to electronic records to the user profile;
receive one or more electronic records and criteria to associate the one or more electronic records to one or more enterprise functions, technology platforms, and enterprise rules;
receive an identification of one or more of electronic records, enterprise functions, technology platforms, and enterprise rules and edits to the identified one or more electronic records, enterprise functions, technology platforms, or enterprise rules;
receive an identification of one or more of electronic records, enterprise functions, technology platforms, and enterprise rules associated with the one or more of electronic records, enterprise functions, technology platforms, and enterprise rules; and
receive a query for one or more of the one or more electronic records, enterprise functions, technology platforms, and enterprise rules; and
one or more processors communicatively coupled to at least one of the one or more memories and the one or more user interfaces, the one or more processors configured to:
authenticate the user authentication credentials to provide access to the user profile corresponding to the user authentication credentials;
provision, according to the received user interface preferences associated with the user profile, one or more of:
information associated with the electronic records to the user profile; and
notifications related to electronic records to the user profile;
associate, according to the received criteria, the one or more electronic records with the one or more enterprise functions, technology platforms, and enterprise rules; and
determine one or more electronic records, enterprise functions, technology platforms, and enterprise rules responsive to the received query.

2. The system of claim 1, the one or more processors further configured to associate the electronic records according to the received criteria into a taxonomy organized by enterprise function; and
the one or more interfaces further configured to display the taxonomy in an interactive form such that selection of a portion of the taxonomy displays information associated with the selected portion of the taxonomy, wherein information associated with the selected portion of the taxonomy includes enterprise rules and technology platforms associated with enterprise functions associated with the selected portion of the taxonomy.

3. A system for managing electronic records, comprising:
one or more memories comprising one or more databases, at least one of the one or more databases configured to store a plurality of electronic records;
one or more user interfaces communicatively coupled to at least one of the one or more memories, the one or more interfaces configured to:
receive one or more electronic records and criteria to associate the one or more electronic records to one or more enterprise functions, technology platforms, and enterprise rules; and
receive a query for one or more of the one or more electronic records, enterprise functions, technology platforms, and enterprise rules; and
one or more processors communicatively coupled to at least one of the one or more memories and the one or more user interfaces, the one or more processors configured to:
associate, according to the received criteria, the one or more electronic records with the one or more enterprise functions, technology platforms, and enterprise rules; and
determine one or more electronic records, enterprise functions, technology platforms, and enterprise rules responsive to the received query.

4. The system of claim 3, the one or more processors further configured to associate the electronic records according to the received criteria into a taxonomy organized by enterprise function.

5. The system of claim 4, the one or more interfaces further configured to display the taxonomy in an interactive form such that selection of a portion of the taxonomy displays information associated with the selected portion of the taxonomy.

6. The system of claim 5, wherein the information associated with the selected portion of the taxonomy includes enterprise rules and technology platforms associated with enterprise functions associated with the selected portion of the taxonomy.

7. The system of claim 3, the one or more interfaces further configured to receive user interface preferences associated with the user profile, the user interface preferences operable to control one or more of:
provisioning of information associated with the electronic records to the user profile; and
provisioning of notifications related to electronic records to the user profile; and
the one or more processors further configured to provision, according to the received user interface preferences associated with the user profile, one or more of:
information associated with the electronic records to the user profile; and
notifications related to electronic records to the user profile.

8. The system of claim 3, the one or more interfaces further configured to receive user authentication credentials for a user profile authorized to access the one or more memories, the user profile having defined system privileges associated with one or more of accessing, editing, and associating electronic records in the one or more databases; and
the one or more processors further configured to authenticate the user authentication credentials to provide access to the user profile corresponding to the user authentication credentials.

9. A non-transitory computer readable medium comprising logic for managing electronic records, the logic, when executed by a processor, operable to
receive one or more electronic records and criteria to associate the one or more electronic records to one or more enterprise functions, technology platforms, and enterprise rules;
store the received one or more electronic records;
receive a query for one or more of the one or more electronic records, enterprise functions, technology platforms, and enterprise rules;
associate, according to the received criteria, the one or more electronic records with the one or more enterprise functions, technology platforms, and enterprise rules; and
determine one or more electronic records, enterprise functions, technology platforms, and enterprise rules responsive to the received query.

10. The non-transitory computer readable medium of claim 9, the logic further operable to associate the electronic records according to the received criteria into a taxonomy organized by enterprise function.

11. The non-transitory computer readable medium of claim 10, the logic further operable to display the taxonomy in an interactive form such that selection of a portion of the taxonomy displays information associated with the selected portion of the taxonomy.

12. The non-transitory computer readable medium of claim 11, wherein the information associated with the selected portion of the taxonomy includes enterprise rules and technology platforms associated with enterprise functions associated with the selected portion of the taxonomy.

13. The non-transitory computer readable medium of claim 9, the logic further operable to:
receive user interface preferences associated with the user profile, the user interface preferences operable to control one or more of:
provisioning of information associated with the electronic records to the user profile; and
provisioning of notifications related to electronic records to the user profile; and
provision, according to the received user interface preferences associated with the user profile, one or more of:
information associated with the electronic records to the user profile; and
notifications related to electronic records to the user profile.

14. The non-transitory computer readable medium of claim 9, the logic further operable to:
receive user authentication credentials for a user profile authorized to access the one or more memories, the user profile having defined system privileges associated with one or more of accessing, editing, and associating electronic records in the one or more databases; and
authenticate the user authentication credentials to provide access to the user profile corresponding to the user authentication credentials.

15. A method for managing electronic records, comprising:
receiving one or more electronic records and criteria to associate the one or more electronic records to one or more enterprise functions, technology platforms, and enterprise rules;
storing the received one or more electronic records;
receiving a query for one or more of the one or more electronic records, enterprise functions, technology platforms, and enterprise rules;
associating, according to the received criteria, the one or more electronic records with the one or more enterprise functions, technology platforms, and enterprise rules; and
determining one or more electronic records, enterprise functions, technology platforms, and enterprise rules responsive to the received query.

16. The method of claim 15, further comprising associating the electronic records according to the received criteria into a taxonomy organized by enterprise function.

17. The method of claim 16, further comprising displaying the taxonomy in an interactive form such that selection of a portion of the taxonomy displays information associated with the selected portion of the taxonomy.

18. The method of claim 17, wherein the information associated with the selected portion of the taxonomy includes enterprise rules and technology platforms associated with enterprise functions associated with the selected portion of the taxonomy.

19. The method of claim 15, further comprising:
receiving user interface preferences associated with the user profile, the user interface preferences operable to control one or more of:
provisioning of information associated with the electronic records to the user profile; and
provisioning of notifications related to electronic records to the user profile; and
provisioning, according to the received user interface preferences associated with the user profile, one or more of:
information associated with the electronic records to the user profile; and
notifications related to electronic records to the user profile.

20. The method of claim 15, further comprising:
receiving user authentication credentials for a user profile authorized to access the one or more memories, the user profile having defined system privileges associated with one or more of accessing, editing, and associating electronic records in the one or more databases; and
authenticating the user authentication credentials to provide access to the user profile corresponding to the user authentication credentials.
